(19) United States
(12) Patent Application Publication
(10) Pub. No.: US 2014/0200909 A1
(43) Pub. Date: Jul. 17, 2014

(54) METHODS AND SYSTEMS FOR ELECTRONICALLY MANAGING HEALTHCARE EXPENSES AND PAYMENTS

(71) Applicant: Citibank, N.A., (US)

(72) Inventors: June Yee Felix, New York, NY (US); Gary Brian Word, Princeton Junction, NJ (US); Paramita Bandyopadhyay, Arlington Heights, IL (US); Sarita James, New York, NY (US); Stuart Mitchell Hanson, Burr Ridge, IL (US)

(73) Assignee: Citibank, N.A., New York, NY (US)

(21) Appl. No.: 13/743,757

(22) Filed: Jan. 17, 2013

(51) Int. Cl. G06Q 20/14; G06Q 50/22

(52) U.S. Cl. CPC G06Q 20/14; G06Q 50/22
USPC 705/2

(57) ABSTRACT

Methods and systems for electronically managing healthcare expenses and payments involve, for example, receiving information from a health plan processor consisting at least in part of an adjudicated balance owed by a user to a healthcare provider, optionally receiving an adjustment of the adjudicated balance from the healthcare provider, and presenting the adjudicated balance and the optional adjustment, if any, to the user. Thereafter, a payment of the user for the adjudicated balance, as optionally adjusted, may be received, and the user's payment, or information therefor, for the adjudicated balance, as optionally adjusted, may be sent to the healthcare provider.

### FIELD OF THE INVENTION

The present invention relates generally to the field of electronic bill presentment and payment, and more particularly to methods and systems for electronically managing healthcare expenses and payments.

### BACKGROUND OF THE INVENTION

Currently, from a patient or consumer perspective, healthcare bills are received by patients from many different sources and are extremely complicated and confusing to pay. For example, it may be very difficult for a patient to match explanation of benefits (EOB) information received from the patient's health insurance company to bills received from various healthcare providers. Moreover, the timing of payment of the bills by the health insurance company may often be out of sync. Thus, there is currently a disconnect between EOBs received from health insurance companies and bills received from the healthcare providers that may lead patients to delay paying primarily because they are confused and are unsure of what to pay.

One reason for a patient's delaying payment is that the patient may want to be sure that his or her health insurance company has paid its portion before the patient pays his or her remaining portion. Further, the patient justifiably wants to know and understand exactly what he or she is paying for. An EOB may provide detail at a claim-by-claim level, such as tests, MRIs, x-rays, and/or general checkups, which may represent different claims for a single episode of care. For example, a patient may be willing to pay for a test and perhaps a general checkup, which the patient may understand. However, the patient may not understand that someone also read the patient's x-rays, and may not be willing to pay for what he or she does not understand. Healthcare bills are typically consolidated and lack details that enable the patient to understand what he or she is being asked to pay. The mismatch between an EOB from the insurance company and bills from physicians and hospitals is a major source of patient confusion.

There is a present need for an integrated platform for managing healthcare expenses and payments that enables bill presentment and payment in healthcare to be aggregated, for example, through a website portal that may be accessed by a user through the user's mobile phone or through the web to allow the user a multi-sided view of patient responsible amounts from health plans and adjusted amounts at the same claim/encounter level from healthcare providers and to click through to health plan diagnostic details.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform the methods described herein. Embodiments of the invention provide methods and systems for electronically managing healthcare expenses and payments that may involve, for example, receiving, using a processor, information from a health plan processor consisting at least in part of an adjudicated balance owed by a user to a healthcare provider; presenting, using the processor, the adjudicated balance to the user; receiving, using the processor, a payment of user for the adjudicated balance; and sending, using the processor, information for the user's payment of the adjudicated balance to the healthcare provider.

In an aspect of embodiments of the invention, receiving the information consisting at least in part of the adjudicated balance may involve, for example, receiving information from the health plan processor consisting at least in part of the adjudicated balance at a claim level. Another aspect may involve, for example, receiving, using the processor, an adjustment of the adjudicated balance from the healthcare provider. In another aspect, receiving the adjustment from the healthcare provider may involve, for example, receiving the adjustment of the adjudicated balance at a claim level from the healthcare provider. In a further aspect, presenting the adjudicated balance to the user may involve, for example, presenting a view of the adjudicated balance and a balance owed by the user after the adjustment.

In an additional aspect, presenting the adjudicated balance to the user may involve, for example, presenting a view at a claim level of the adjudicated balance to the user. In a still further aspect, presenting the adjudicated balance to the user may involve, for example, presenting a view at an encounter level of the adjudicated balance to the user. In an additional aspect of embodiments of the invention, presenting the adjudicated balance to the user may involve, for example, presenting a view at a diagnostic detail level of the adjudicated balance to the user. In a further aspect, presenting the adjudicated balance to the user may involve, for example, presenting a view of the adjudicated balance with a link to financial and diagnostic detail related to the adjudicated balance. In other aspects, presenting the adjudicated balance to the user may involve, for example, presenting the adjudicated balance to the user via a mobile phone application message, an email message, an SMS text message, or an interactive voice response message. In still another aspect, presenting the adjudicated balance to the user may involve, for example, presenting an alert of the adjudicated balance to the user.

In a further aspect of embodiments of the invention, receiving the payment of the user for the adjudicated balance may involve, for example, receiving the payment via a digital wallet of the user's computing device. In additional aspects, receiving the payment via the digital wallet of the user's computing device may involve, for example, receiving the payment from at least one of a plurality of payment sources according to a predefined payment hierarchy stored on the digital wallet. In another aspect, receiving the payment via the digital wallet of the user's computing device may involve, for example, receiving the payment from at least on of a plurality of payment sources selectable by the user via the digital wallet at a time the user instructs the payment to be made. In still another aspect, receiving the payment from at least one of the plurality of payment sources may involve, for example, receiving the payment from at least one of a tax advantaged account, a credit card account, a demand deposit account, a rewards points account, and transactional financing.

In a still further aspect, receiving the payment from at least one of the plurality of payment sources according to the predefined hierarchy may involve, for example, receiving at least a portion of the payment from a first account and a balance of the payment from a second account according to the predefined payment hierarchy. In another aspect, receiving the payment of the user for the adjudicated balance may involve, for example, receiving a payment schedule for at least a portion of the payment for the adjudicated balance.

In still another aspect of embodiments of the invention, sending the information for the user's payment may involve, for example, sending the information for the user's payment for the adjudicated balance, aggregated with information for payments of balances owed to the healthcare provider by a plurality of other users, to the healthcare provider. In other aspects, sending the information for the user's payment may involve, for example, sending the information for the user's payment to a financial institution account for the healthcare provider. In an additional aspect, sending the information for the user's payment may involve, for example, sending claim level detail for the payment to the healthcare provider. In a further aspect, sending the information for the user's payment may involve, for example, sending a payment schedule for at least a portion of the payment to the healthcare provider. In other aspects, sending the information for the user's payment may involve, for example, sending an instruction for the user's payment to the healthcare provider. In additional aspects, sending the information for the user's payment may involve, for example, sending the user's payment to the healthcare provider.

Other aspects of embodiments of the invention may involve, for example, sending or receiving, using the processor, registration details for the user. In a further aspect, sending or receiving the registration details for the user may involve, for example, sending or receiving the registration details for the user via the health plan processor to or from, respectively, a digital wallet of the user's computing device. In an additional aspect, sending or receiving the registration details via the health plan processor to or from, respectively, the digital wallet may involve, for example, sending or receiving the registration details consisting at least in part of a predefined payment hierarchy.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram that illustrates an overview example of components and a flow of information between components of the platform for embodiments of the invention;

FIG. 2 is a flow chart that illustrates an overview example of the process of presenting claims-related information and receiving payment for embodiments of the invention;

FIG. 3 illustrates an example of a dashboard home page for the platform for embodiments of the invention;

FIGS. 4A and 4B illustrate examples of a provider's adjustment aspect of the dashboard home page for embodiments of the invention;

FIG. 5 illustrates an example of a claims view table page for the platform for embodiments of the invention;

FIGS. 6A and 6B illustrate additional examples of claims folder detail aspects of the dashboard home page for embodiments of the invention;

FIG. 7 illustrates a further example of a claims folder detail aspect of the dashboard home page for embodiments of the invention; and

FIG. 8 is a flow chart that illustrates another overview example of the process of presenting claims-related information and receiving payment for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Embodiments of the invention provide an integrated platform for managing healthcare expenses and payments that enables bill presentment and payment in healthcare to be aggregated, for example, through a website portal that may be accessed by a user through the user's mobile phone or through the web. The platform for embodiments of the invention may also enable users to pay their healthcare bills online via a user's linked payment account or accounts. The user's linked payment account or accounts may include, for example, one or more tax advantaged accounts, such as a health savings account (HSA), a flexible spending account (FSA), or a health reimbursement arrangement (HRA), and one or more non-tax advantaged accounts, such as a checking account, a credit card account, or a debit card.

An aspect of the platform for embodiments of the invention may involve, for example, using and aggregating data from various insurance companies. Another aspect of the platform may involve, for example, presenting bill information to a user with an EOB after a claim is processed and a balance is determined. A further aspect of the platform may involve, for example, presenting an aggregated view of the bills across multiple different healthcare providers and for all members of the same household. In embodiments of the invention, an adjudicated claim (i.e., a negotiated charge after insurance payment) from a health plan administrator may be presented to the user as an aggregated view of the bills across multiple providers and across all patients in the household (e.g., spouse and children) that are on the same plan.

Embodiments of the invention may enable a user to make and issue a single decision with a click to authorize payments to multiple healthcare providers, for example, via email, SMS text, mobile app alert, or website portal. Further, a single payment may be pulled from one or more of the user's previously designated and linked financial accounts. The platform for embodiments of the invention may also enable a user to have a single payment pulled from both a linked tax advantaged account and a linked non-tax advantaged account. For example, funds eligible for tax advantaged treatment may be pulled from a linked tax advantaged account until that account is exhausted and thereafter from one or more non-tax advantaged accounts. Further, using the platform for embodiments of the invention, a record of the amount that was eligible for tax advantaged treatment but was not applied to the bill may be stored. When additional pre-tax funds are added to the tax advantaged account, the funds may automatically be pulled from the tax advantaged account and reimbursed into a linked checking account. In addition, payments for separate patients to each healthcare provider may be batched together and sent to the providers.

Embodiments of the invention may provide a digital wallet for users that may be linked, for example, to a centralized healthcare portal through which users may also enroll in a healthcare plan. In a linking aspect, a member identifier token, such as a current membership card, may be used to link a user's relationship with a healthcare insurance company through a digital wallet. In embodiments of the invention, the member identifier for a user who may have multiple memberships with the same healthcare insurance company or memberships with multiple different insurance companies, such as a user who is a subscriber on a health plan but who may also have benefits under a spouse's dental plan, may be used to link the user's relationship with all of the plans as currently constituted or as any of those plans may be changed over time. In the linking aspect, the user and the user's relationship may be linked with the insurance company or companies to the user's digital wallet and/or to the user's existing financial accounts, such as checking accounts, credit card accounts, tax advantaged accounts (e.g., HRA, HSA, or FSA), rewards accounts (e.g., in which points may be transformed into a currency equivalent), or prepaid debit card accounts.

Embodiments of the invention may also involve, for example, an electronic or e-billing aspect. In the e-billing aspect, major healthcare providers may enroll directly for billing services so that such providers' patients may have access to the portal for embodiments of the invention, even though their patients do not necessarily enroll with a participating health plan administrator. In such case, the platform for embodiments of the invention may still receive health claim details from the health plan administrator regarding the patient's responsibility, and the funding options through the digital wallet may still be available. It is to be understood that the platform for embodiments of the invention may capture and present bills across multiple healthcare providers and is not limited to presentment and payment for a single healthcare provider.

The system for embodiments of the invention may be an opt-in only system. Thus, enrollment may be offered to users, but users must actually opt in to membership and agree to participate in order to become members. In the enrollment aspect, users may register, for example, through their health plan, allowing the users to see all of their healthcare bills for their covered providers. Health plan members may initiate registration, for example, as part of their annual health plan enrollment process or as a stand-alone process. In the enrollment process, the user may add payment accounts, such as a checking account, a bank debit card, one or more credit card accounts, tax advantaged accounts (e.g., HRA, HSA, FSA), and/or reward points accounts. In the enrollment process, the user's identity and his or her authority to access the financial accounts may be verified by the platform for embodiments of the invention. Further aspects of embodiments of the invention enable enrollment of users via a healthcare plan and integration with the health plan website for EOBs. A user may also choose a preference for alerts that includes the user's responsibility, such as mobile alerts, email alerts, text alerts, or automated phone call alerts.

In a presentment aspect, the platform for embodiments of the invention may receive, for example, detailed information regarding a visit to a healthcare provider from a health plan administrator, such as the health insurance company that administers the claims and pays the portion covered by the user's health insurance plan. In a multi-sided view aspect of embodiments of the invention, the detailed information may be presented in a simple way to the user with a comparison to what the healthcare provider says is owed. Based on such presentation, the user may be able to understand exactly what is owed. In the multi-sided view aspect, the presentation for the user may also include financial information, such as adjustments that may have been made by the healthcare provider. From time-to-time a healthcare provider may make such adjustments to the bill, for example, when co-payments are made by the user to the provider at the point-of-care. Such adjustments may be made before the bill is presented to the user by the platform for embodiments of the invention. When the claims information is received by the platform from a health plan administrator, all of a user's bills from all enrolled healthcare providers may be consolidated for the user in a single, simple presentation. The platform may link financial information and diagnostic detail received from a health insurance company for each claim, which may include any financial adjustments made by the healthcare provider for each claim in the presentation to the user.

The platform for embodiments of the invention may receive information regarding claim activity related to the user, such as when there is a new claim or a change in the status of an existing claim of the user. Upon receiving such information, the platform for embodiments of the invention may query the insurance company for information regarding a complete set of claims that the particular user may be eligible to view through the system. A reason for such query is a degree of care that must be taken by insurance companies and others under patient privacy laws and regulations. The user's entitlement to view particular claim information on a previous occasion may not necessarily mean that the user may be entitled to continue to view the claim information on a subsequent occasion. Thus, when a user logs on the platform website for embodiments of the invention, it must first be determined from the insurance company what claim information obtained from the insurance company the user may be entitled to view. If the user was allowed on a previous occasion to view claim information which the insurance company now says is restricted, the user may not be allowed to view such claim information obtained from the insurance company on the current occasion. Embodiments of the invention may also include a protection of dependents' privacy aspect

Claim information may be received by the platform for embodiments of the invention from a health plan administrator and may be adjusted based upon information received from major healthcare providers, based on entry of information received from smaller healthcare providers through the website, or based on entry of information by the user. Such adjustments may involve, for example, reductions by the healthcare provider as a result of payments that were made at the point-of-care or forgiveness of a particular charge, or the adjustments may involve an increase by the healthcare provider. The platform for embodiments of the invention may receive claims information in a number of different ways. For example, claims information may be received electronically from a health insurance company in a daily batch feed. The platform for embodiments of the invention may furnish the insurance company the identities of members enrolled for the services provided by the platform, and the insurance company may send claims information regarding such members electronically in a batch feed or in a service call. This may be followed up by other service calls to the insurance company to obtain specific details about particular members and to supplement a local claims cache of the platform for embodiments of the invention.

The claims information may be received by the platform from the insurance company daily, such as each night. Such information may include, for example, the identities of members who have new claim activity or whose claim activity may have changed. When new members enroll, the platform for embodiments of the invention may pull the claims information from the insurance company or may notify the insurance company of the enrollment of such new members, in which case the insurance company may push the claims information to the system. The platform for embodiments of the invention may integrate with major healthcare providers and exchange data directly with such providers through electronic file feeds. However, the platform may not receive direct data feeds from small or medium healthcare providers. Therefore, such providers may provide input, for example, by visiting the portal website for embodiments of the invention to review the claims information and history and to approve or adjust a user's balance up or down. The health plan information or the EOB level information with respect to the health care claims may be received electronically by the platform for embodiments of the invention either from the health plan or from the health care provider. The provider balance due information may be received electronically by the platform for embodiments of the invention either by direct feed from the provider, by service calls or over the portal website through the review and adjustment process.

An aspect of the platform for embodiments of the invention involves, for example, reconciliation and presentation of amounts paid by a health plan administrator and by a tax-advantaged accounts administrator and amounts that a healthcare provider says it is owed in an aggregated way at a claim level detail. An aggregation model aspect of the platform for embodiments of the invention may involve, for example, presenting an aggregated view of a user's bills across multiple healthcare providers and across all patients in the same household who are on one or more of the same healthcare plans. An adjudicated claim from a health plan administrator may be presented by the platform to the user for an amount that the user may owe his or her healthcare provider for a specific service. It is to be noted that presenting the adjudicated claim for the amount the user may owe the healthcare provider for a specific service differs from the current practice in which user payments are made against a balance on an account, but not for a specific healthcare event. It is to be further noted that presenting the adjudicated claim for the amount the user may owe for a specific service also differs from the current practice in that the user's obligation is determined from the health plan administrator's processed claim information instead of waiting for a bill from the healthcare provider. In embodiments of the invention, the user may be presented with an aggregated view of bills across multiple healthcare providers and across all patients in the user's household, such as the user's spouse and children, who are on one or more of the same healthcare plans. Embodiments of the invention may also enable a user to note previous payments, such as cash payments made at the point-of-care in the office of a provider, such as a doctor or hospital, which may decrease the amount owed by the user.

In an alert aspect, the platform for embodiments of the invention may provide an adjudication alert to the user. Thus, within a day from the time the user's claim is adjudicated by the insurance company, the user may be provided with an alert that tells the user the amount that the insurance company will pay on a particular claim or instructions on how the user may find this information through the platform. The user may receive prompt alerts of the user's responsibility via mobile, text, email or interactive voice response. Upon receiving an alert, a user may pay immediately from the alert via mobile, email, text or phone or may request details. After payment, the user may receive confirmation of the payment. The user may use a mobile app or a website portal for embodiments of the invention, for example, to make payments, schedule payments, adjust prior point-of-care payments, such as cash payments, review past payments, or configure auto-pay options.

In a payment aspect, the platform for embodiments of the invention may provide a mechanism for a user to pay the user's portion of each claim, to schedule the user's payments, and to create a hierarchy of such payments against a digital wallet. The platform for embodiments of the invention may also provide information to healthcare providers that may include claim level detail of what each user is paying. Such information may be provided to the healthcare providers in a batch file. Embodiments of the invention may allow users to schedule payments to healthcare providers with information being furnished to the provider of the user's intention to make such recurring payments, and may also make such scheduled payments visible to healthcare providers. The platform for embodiments of the invention may provide a user portal and a healthcare provider portal. The provider portal may allow healthcare providers to view details for each patient of what payments may have been made and what payments may have been scheduled by the user in order to reconcile amounts that have been paid and scheduled against the healthcare provider's account records. In the user portal aspect, a mobile or web-based option may allow a user, for example, to make payments to healthcare providers by simply clicking on a payment button on a display screen.

Embodiments of the invention may include, for example, an insurance exchange mobile or web option that may enable users to make payments, schedule payments, and/or review past payments. In the user payment aspect, a user may be provided with an account number representing their digital wallet, which may be provided, for example, through a physical companion card, with which to pay the healthcare provider, for example, at the point-of-care. Other aspects may involve, for example, a digital wallet account number and virtual payment options that enable a user to make a payment at the point-of-care utilizing features of the user's digital wallet by either swiping a physical card or using the near field communication capability of the user's mobile device to interact with the point-of-sale terminal or showing or scanning a token, such as a QR code. Users may also make payments to healthcare providers, for example, via an interactive voice response (IVR) system.

In addition to receiving claims information from insurance companies and healthcare providers, embodiments of the invention may also involve communications with administrators of financial accounts, such as tax advantaged accounts. Upon receiving information regarding payments made through such payment facilities on behalf of users, the user's remaining balance may be adjusted to assure that the healthcare provider does not receive an overpayment that must be refunded. Thus, embodiments of the invention may involve reconciling information from the health insurance companies with information received from the healthcare providers, as well as with financial account administrators, such as tax advantaged account administrators to accurately determine the remaining balance that the user must pay and avoid the need to deal with refunds. Embodiments of the invention also involve verifying that particular claims may be paid or partially paid from a tax advantaged account. For users who pay their insurance premiums from their checking account, embodiments of the invention may involve, for example, automatically populating a checking account option, so that when a user pays his or her insurance premium, the user may be enabled to preregister and receive refunds for any HSA payments directly into his or her checking account.

In embodiments of the invention the sources of funds for patient payments may include, for example, the patients' debit cards, credit cards, and checking accounts. Users may also have tax advantaged accounts that may be accessed, for example, through a debit card transaction or through a closed loop transaction via mobile, web or interactive voice response payment. Alternatively, users may access such accounts using, for example, a type of virtual currency or a transactional loan. When payments are received by the platform for embodiments of the invention, the payments for each healthcare provider may be aggregated and a single aggregated payment that is net of service fees may be sent in a batch to the provider or to the provider's selected bank. In embodiments of the invention, one or more payment instructions may be sent to each healthcare provider which they can present to their financial institution for payment. For each aggregated batch of payments that is sent to the provider or its bank, a batch file may also be sent to the provider on a daily basis with claim details by patient and by claim to provide transparency and to remove any doubt as to exactly which claim or claims each patient intended to pay.

The user may make a single decision to authorize payments to multiple healthcare providers. The user may also be enabled to issue an authorization decision from multiple interaction channels, such as email, SMS text, mobile app, a website portal and through an interactive voice response system. Embodiments of the invention may also enable a single payment to be pulled from multiple, previously linked financial accounts, including both tax advantaged accounts and non-tax advantaged accounts of a user. Other aspects of embodiments of the invention may provide links to medical expense concierge services and other services, such as free online medical care scheduling services and online symptom checking and provider choosing platforms, to make it easy for users to pay or make arrangements for payment at the time of an appointment.

In addition, the platform for embodiments of the invention may be used to help accelerate payment of ‘click-through’ rates at a private health insurance exchange. For example, once a user selects a health plan preference and applies for the selected health plan, a private health insurance exchange may offer the platform for embodiments of the invention as a convenient payment mechanism for premiums. Further, the platform for embodiments of the invention may allow users to pay from a range of different banks and different accounts and may help users keep track of all of their health related spending in one convenient place. Additional aspects of embodiments of the invention enable, for example, batch payments to healthcare providers at a claim level including unique value added components such as scheduled payment visibility that is not available through currently existing systems

In a payment hierarchy aspect, the digital wallet for embodiments of the invention may include a default function to set hierarchies across funding sources for making user payments. The hierarchy of such funding sources may include, for example, a tax advantaged account, such as a HSA, FSA, or HRA. In addition, the funding source hierarchy may include, for example, a checking account, a debit card, a credit card, a prepaid card, reward points, transaction level financing, and/or one or more layaway type plans. In embodiments of the invention, when initiating payments, a user may declare which account he or she wants to have as the primary account, and may also identify a secondary account if for any reason the transaction with the primary account fails. Thus, after a partial payment is made from one account that exhausts the account, a fallback account may be used to pay the remaining balance. Assume, for example, that a user owes $300 but has only $200 remaining to spend in one of his or her accounts. Using his or her digital wallet, the user may pay the $300 first from the $200 in the first account and the remaining $100 from the next account in the digital wallet hierarchy, which may be, for example, a checking account of the user. An ultimate backup account may be a transaction financing account. The transaction financing account may depend on factors such as a particular level of risk and/or a transaction size and type of transaction that may lead to a spot loan for the user for a particular transaction.

The hierarchy aspect of embodiments of the invention may provide a breadth of funding types and an ability to set default hierarchies across funding types as well as a wide range of use cases. In the hierarchy aspect, when the user's HSA is used, eligible funds may be pulled from the HSA until it is exhausted, and thereafter, funds may be pulled from, for example, non-tax advantaged accounts of the user for payment of any unpaid balance. In this aspect, a record of the amount that was eligible for tax-advantage treatment but not applied to the HSA because the account became exhausted may be stored, using the platform for embodiments of the invention. Thereafter, when additional pre-tax funds may have been added to the user's HSA, funds may be automatically pulled from the HSA as a reimbursement and placed in a linked checking account of the user. Similarly, funds may likewise be pulled first from the user's FSA for all billed items that are eligible for the FSA, and if the FSA becomes exhausted, the remaining FSA-eligible amount may be pulled from a non-FSA account of the user. Any remainder of the FSA-eligible amount plus all non-FSA eligible amounts may thereafter be pulled from other, non-tax advantaged accounts of the user, and a record of the amount that was eligible for tax-advantaged treatment but not applied to the FSA because the account became exhausted may likewise be stored.

Thus, in embodiments of the invention, it is not necessary for the user to remember that certain charges may have been eligible for tax advantaged treatment but not applied because of insufficient tax advantaged funds, and to apply the charges to the tax advantaged account when the tax advantaged funds may later become available. Further, in embodiments of the invention, administrators of tax advantaged accounts may be enabled to authorize and settle funds from such accounts and may be provided additional information that may be used to reduce a need for post-payment substantiation.

Still further aspects of embodiments of the invention may provide auto registration of accounts held or administered by partner companies into a digital wallet. In the digital wallet aspect of embodiments of the invention, a user may place many types of payment accounts in his or her digital wallet with which to make healthcare payments simply and securely. Using the digital wallet for embodiments of the invention, payment options may include, for example, the hierarchy of payment sources, such as a tax advantaged account (e.g., HSA, FSA, or HRA), checking account or debit card, credit card or prepaid card, reward points, or transaction level financing and layaway type plans. Such payments using the digital wallet may be made, for example, via desktop computer, payment card, or mobile app. A user may also use his or her digital wallet for embodiments of the invention, for example, for payment when buying a health plan, including monthly premiums or when prepaying at the time an appointment is scheduled. In addition, the user may use the digital wallet, for example, when paying at a doctor's office, clinic, or hospital or when paying for post care of an amount after insurance. The user may also use his or her digital wallet, for example, when paying for drugs, wellness, vision, or dental expenses or when paying for COBRA or Supplemental Part B and D coverage.

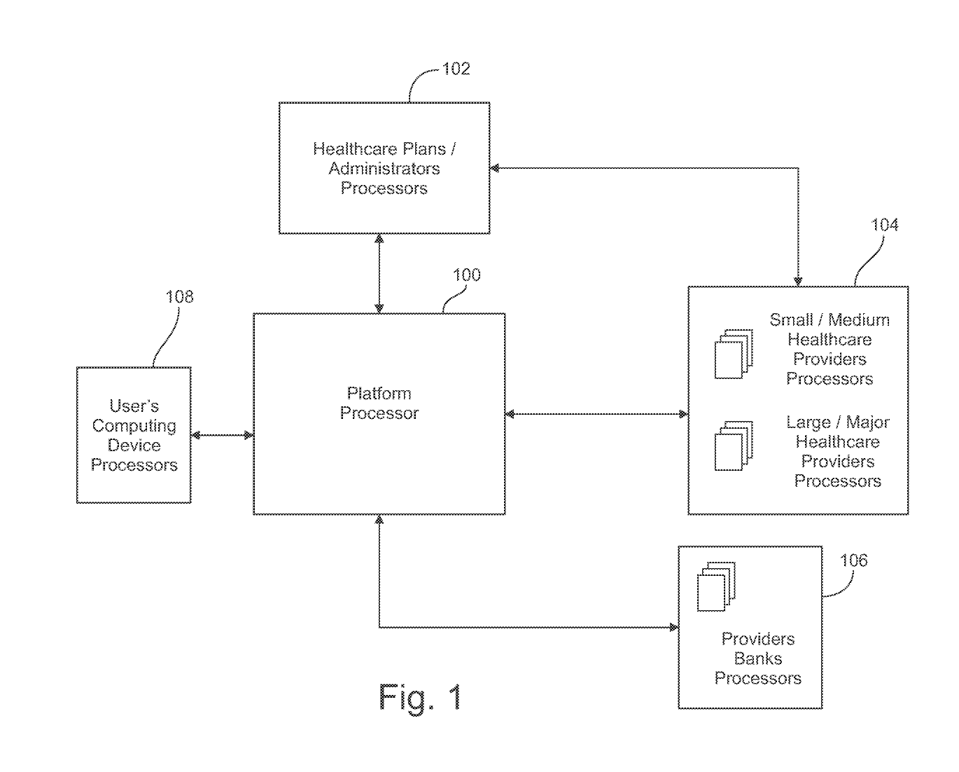

FIG. 1 is a schematic diagram that illustrates an overview example of components and a flow of information between components of the platform 100 for embodiments of the invention. Referring to FIG. 1, the platform 100 for embodiments of the invention may include one or more processors coupled to memory. In addition, the platform processor may be coupled electronically to one or more health plan administrator processors 102, one or more healthcare provider processors 104, one or more financial institution processors 106, and one or more user computing device processors 108.

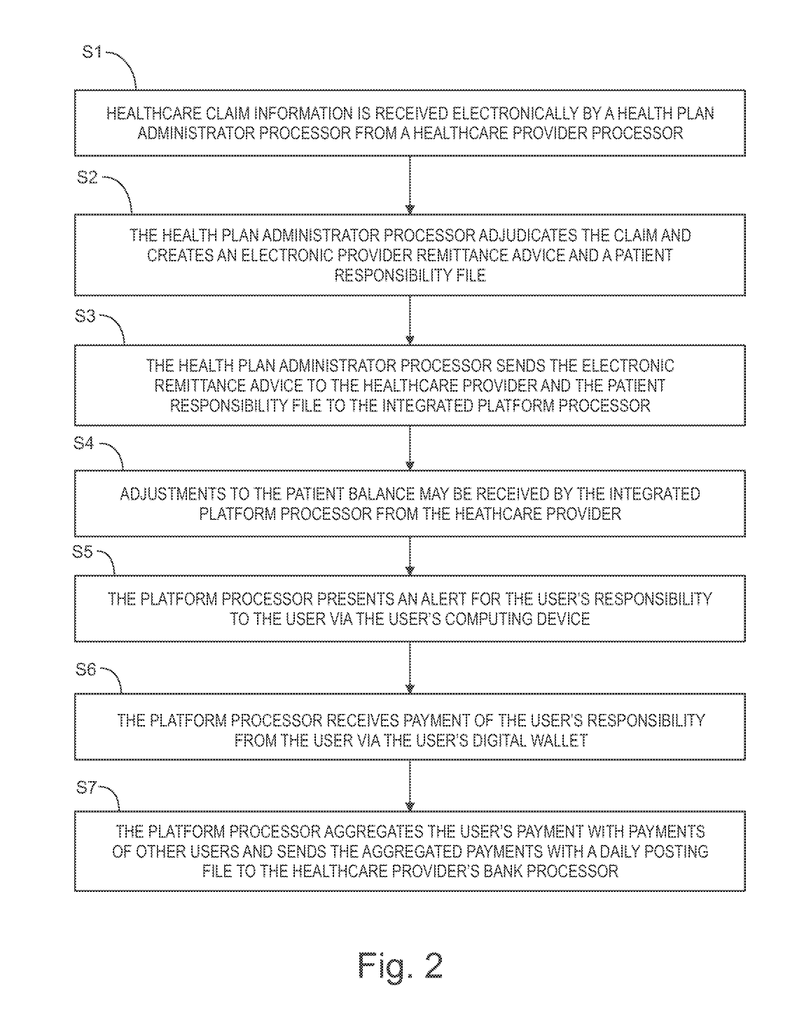

FIG. 2 is a flow chart that illustrates an overview example of the process of presenting claims-related information and receiving payment for embodiments of the invention. Referring to FIG. 2, at S1, healthcare claim information may be received electronically by a health plan administrator processor 102 from a healthcare provider processor 104. The claim information may be received, for example, in the form of a transaction set in an EDI 837 format that meets HIPAA requirements for electronic submission of such information. At S2, upon receiving the claim, the health plan administrator processor 102 may adjudicate the claim and create an electronic provider remittance advice and a patient responsibility file. The provider electronic remittance advice may be created, for example, in the form of a HIPAA-compliant 835 format electronic remittance advice.

Referring further to FIG. 2, at S3, the health plan administrator processor 102 may send the electronic remittance advice to the healthcare provider 104 and send the patient responsibility file to the integrated platform processor 100. At S4, adjustments to a patient balance may be received by the integrated platform processor 100. The adjustments may be received from a healthcare provider 104, such as a small or medium sized provider, in a provider's review of the patient balance via a portal provided, for example, by the platform 100 for embodiments of the invention. Alternatively, the adjustments may be determined, for example, from a billing file received from the healthcare provider 104, such as a larger sized provider, and linked to an EOB summary received from the health plan administrator 102. The user responsibility may be derived from EOB data received from the health plan administrator 102 as reduced by any co-payment.

Referring again to FIG. 2, at S5, the integrated platform processor 100 may present an alert to the user via a processor of the user's computing device 108 that includes the user's responsibility. The alert may be presented for the user via a digital healthcare expense wallet for embodiments of the invention on which the user may review the user's responsibility and the EOB. The user may likewise use the digital wallet to view and redeem offers. At S6, the platform processor 100 may receive payment of the user's responsibility sent by the user via the user's digital wallet on the user's computing device 108. At S7, the integrated platform processor 100 may aggregate the user's payment with payments of other users and send the aggregated payments with a daily posting file, for example, to the healthcare provider's bank processor 106. In embodiments of the invention, a daily posting file may be sent to a provider 104, such as a major healthcare provider, and a posting file and report may sent to a provider 104, such as a medium or small healthcare provider, or may be made available to the provider, for example, through a web site.

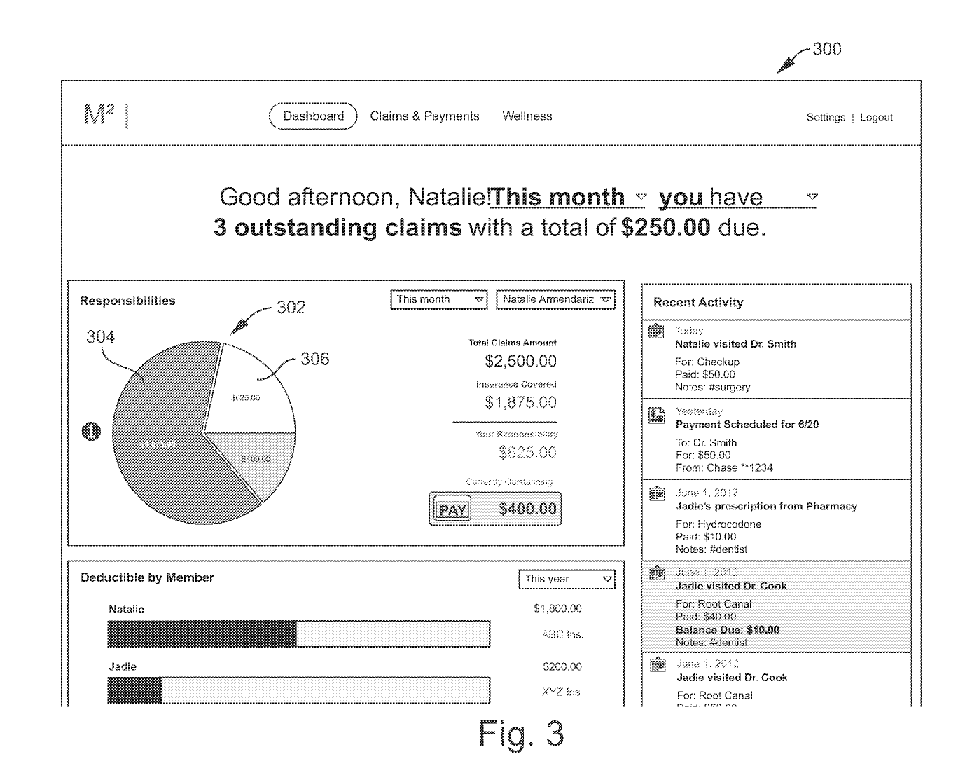

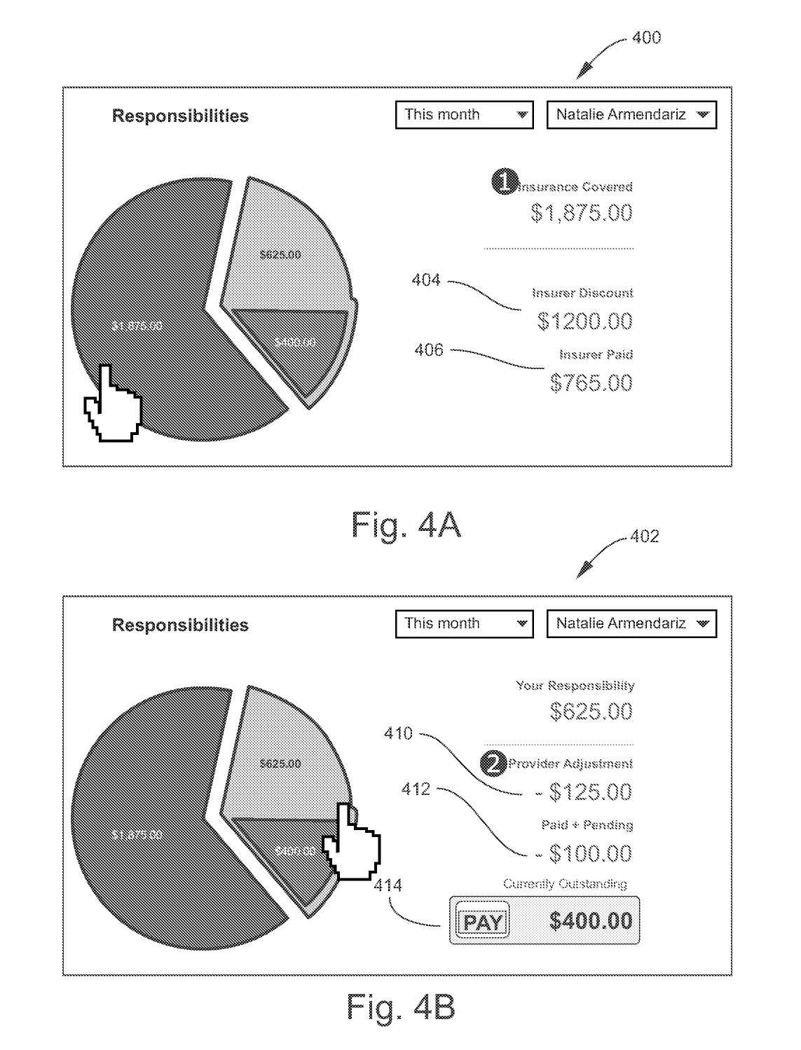

FIG. 3 illustrates an example of a dashboard home or landing page 300 for the platform for embodiments of the invention. Referring to FIG. 3, the landing page 300 may show an overview of responsibilities. For example, a user may click an icon, such as a pie chart graph 302, to see more details. FIGS. 4A and 4B illustrate examples 400 and 402 respectively of a provider's adjustment aspect of the dashboard home page for embodiments of the invention. Referring to FIGS. 3 and 4A, when a user clicks on an insurance portion 304 of the pie chart graph 302 of FIG. 3, the user's insurance coverage may be shown broken down, for example, into an insurer discount portion 404 and an insurer paid portion 406 on FIG. 4A. Referring to FIGS. 3 and 4B, when the user clicks on a patient portion 306 of the pie chart graph 302 in FIG. 3, a breakdown may be shown of the responsibilities, such as a provider discount or addition 410, an amount paid plus pending 412, and an amount currently outstanding 414 in FIG. 4B. If an adjustment adds to the user's responsibility, an attention icon may also be shown.

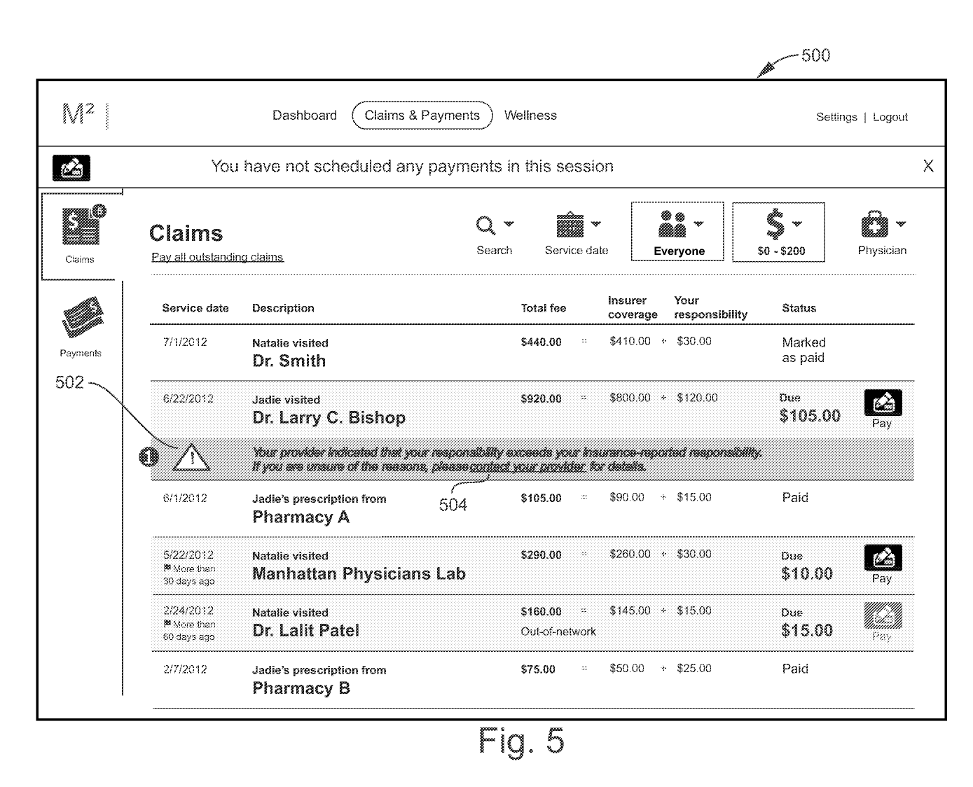

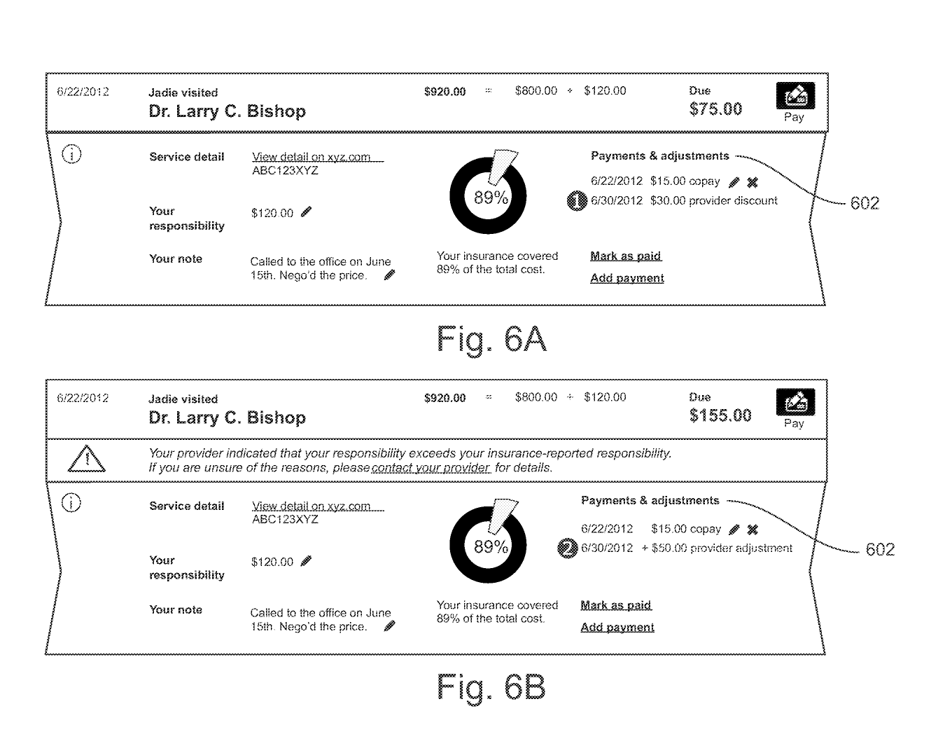

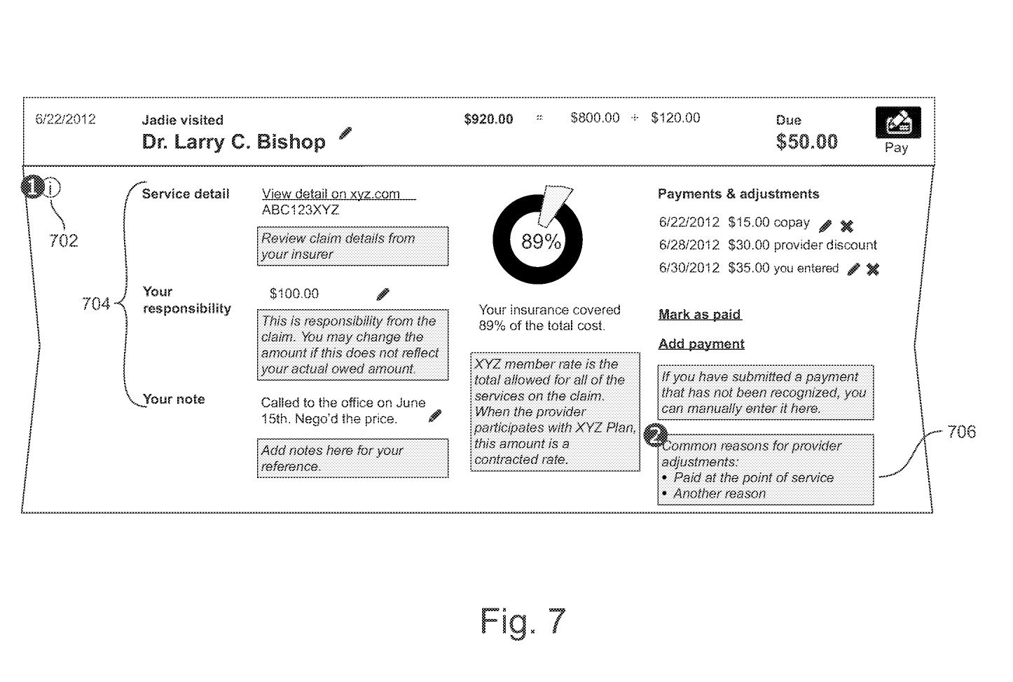

FIG. 5 illustrates an example of a claims view table page 500 for the platform for embodiments of the invention. Referring to FIG. 5, when the provider's adjustment exceeds an insurer's estimation, an error message 502 may appear online. If the provider's contact information is available, a ‘Contact Your Provider’ link 504 may be provided. Clicking on the ‘Contact Your Provider’ link 504 may show the provider's contact information. FIGS. 6A and 6B illustrate additional examples of claims folder detail aspects of the dashboard home page for embodiments of the invention. Referring to FIG. 6A, when there is an adjustment from the provider, the details of the adjustment may be listed in a ‘Payments & Adjustments’ section 602. Referring to FIG. 6B, when the claim detail folds out for the user, a detailed adjustment may be shown in the ‘Payments & Adjustments’ section 602. FIG. 7 illustrates a further example of a claims folder detail aspect of the dashboard home page for embodiments of the invention.

Referring to FIG. 7, the user may click on an information button 702, such as a button labeled ‘I”, to reveal instructions or explanations 704 about what each listing means. In addition, a ‘Common Reasons for Adjustments’ section 706 may show examples of common occurrences which may result in adjustments.

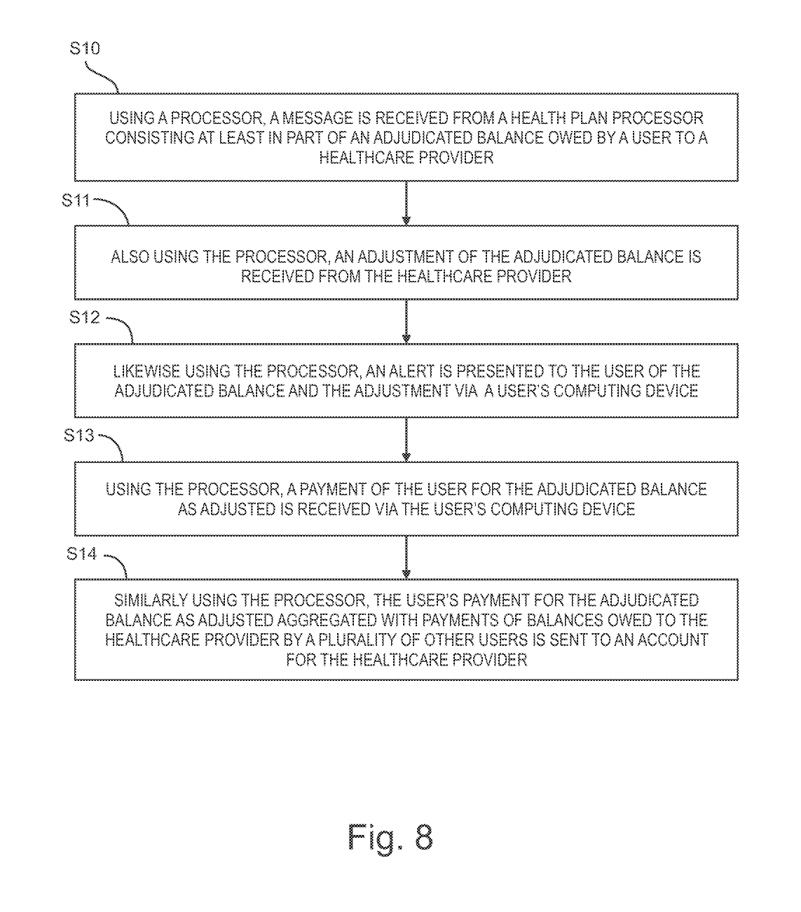

FIG. 8 is a flow chart that illustrates another overview example of the process of presenting claims-related information and receiving payment for embodiments of the invention. Referring to FIG. 8, at S10, using a platform processor 100, information may be received from a health plan processor 102 consisting at least in part of an adjudicated balance owed by a user to a healthcare provider 104. At S11, also using the processor 100, an adjustment of the adjudicated balance may be received from the healthcare provider 104. Thereafter, at S12, likewise using the processor 100, an alert may be presented to the user of the adjudicated balance and the adjustment via a user's computing device 108. At S13, using the processor 100, a payment of the user for the adjudicated balance as adjusted may be received via the user's computing device 108, and at S14, similarly using the processor 100, the user's payment for the adjudicated balance as adjusted, aggregated with payments of balances owed to the healthcare provider 104 by a plurality of other users, may be sent to an account 106 for the healthcare provider 104. In another embodiment of the invention, at S14, the user's payment may be made by sending one or more payment instructions to the healthcare provider 104 for a single or a plurality of other users, after which the healthcare provider 104 may present the payment instructions to the provider's bank processor 106 for payment.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is to be further understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, near-field communication, or other transmission device or channel, both wired or wireless. Such instructions may comprise code from any suitable computer programming language including, without limitation, C, C++, C#, Visual Basic, Java, Python, Perl, and JavaScript.

It is to be still further understood that client devices that may be employed by embodiments of the invention may also comprise a number of external or internal devices, such as a mouse, a CD-ROM, DVD, keyboard, display, point-of-sale terminal, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices.

1. A method for managing healthcare expenses and payments, comprising:
receiving, using a processor, information from a health plan processor consisting at least in part of an adjudicated balance owed by a user to a healthcare provider;
presenting, using the processor, the adjudicated balance to the user consisting at least in part of a combined view at a claim level and an encounter level of the adjudicated balance by the healthcare provider and with a link to the health plan processor's financial and diagnostic detail of the adjudicated balance;
receiving, using the processor, a payment of the user for the adjudicated balance;
sending, using the processor, information for the user's payment of the adjudicated balance consisting at least in part of claim-by-claim level detail for the user's payment, aggregated with information consisting at least in part of claim-by-claim level detail for payments of balances owed to the healthcare provider by a plurality of other users, to the healthcare provider; and
sending, using the processor, the user's payment for the adjudicated balance, aggregated with payments of balances owed to the healthcare provider by the plurality of other users, to an account for the healthcare provider.

2. The method of claim 1, wherein receiving the information consisting at least in part of the adjudicated balance further comprises receiving information from the health plan processor consisting at least in part of the adjudicated balance at the claim level.

3. The method of claim 1, further comprising receiving, using the processor, an adjustment of the adjudicated balance from the healthcare provider.

4. The method of claim 3, wherein receiving the adjustment from the healthcare provider further comprises receiving the adjustment of the adjudicated balance at the claim level from the healthcare provider.

5. The method of claim 3, wherein presenting the adjudicated balance to the user further comprises presenting a view of the adjudicated balance and a balance owed by the user after the adjustment.

6-8. (canceled)

9. The method of claim 1, wherein presenting the adjudicated balance to the user further comprises presenting notification of the adjudicated balance to alert the user via a mobile phone application message, an email message, an SMS text message, or an interactive voice response message.

10. The method of claim 1, wherein receiving the payment of the user for the adjudicated balance further comprises receiving the payment via a user's digital wallet using the processor.

11. The method of claim 10, wherein receiving the payment via the digital wallet using the processor further comprises receiving the payment from at least one of a plurality of payment sources according to a predefined payment hierarchy stored on the digital wallet.

12. The method of claim 10, wherein receiving the payment via the digital wallet using the processor further comprises receiving the payment from at least one of a plurality of payment sources selectable by the user via the digital wallet at a time the user instructs the payment to be made.

13. The method of claim 11, wherein receiving the payment from at least one of the plurality of payment sources further comprises receiving the payment from at least one of a tax advantaged account, a credit card account, a demand deposit account, a rewards points account, and transactional financing.

14. The method of claim 11, wherein receiving the payment from at least one of the plurality of payment sources according to the predefined hierarchy further comprises receiving at least a portion of the payment from a first account and a balance of the payment from a second account according to the predefined payment hierarchy.

15. The method of claim 1, wherein receiving the payment of the user for the adjudicated balance further comprises receiving a payment schedule for at least a portion of the payment for the adjudicated balance.

16-18. (canceled)

19. The method of claim 1, wherein sending the information for the user's payment further comprises sending a payment schedule for at least a portion of the payment to the healthcare provider.

20. The method of claim 1, wherein sending the information for the user's payment further comprises sending an instruction for the user's payment to the healthcare provider.

21. The method of claim 1, further comprising sending or receiving, using the processor, registration details for the user.

22. A system for managing healthcare expenses and payments, comprising:
a processor coupled to memory, the processor being programmed for:
receiving information from a health plan processor consisting at least in part of an adjudicated balance owed by a user to a healthcare provider;
presenting the adjudicated balance to the user consisting at least in part of a combined view at a claim level and an encounter level of the adjudicated balance by the healthcare provider and with a link to the health plan processor's financial and diagnostic detail of the adjudicated balance;
receiving a payment of the user for the adjudicated balance; and
sending information for the user's payment for the adjudicated balance, consisting at least in part of claim-by-claim level detail for the user's payment, aggregated with information consisting at least in part of claim-by-claim level detail for payments of balances owed to the healthcare provider by a plurality of other users, to the healthcare provider; and
sending the user's payment for the adjudicated balance, aggregated with payments of balances owed to the healthcare provider by the plurality of other users, to an account for the healthcare provider.
